(19) United States
(12) Patent Application Publication
(10) Pub. No.: US 2012/0194340 A1
(43) Pub. Date: Aug. 2, 2012

(54) PERMANENT WIRELESS COMMUNICATION SYSTEM FOR MONITORING CONTAINERS BURIED IN AN ENCLOSED AREA USING BATTERY-LESS GPS RECEIVERS

(75) Inventor: TAI CHEUNG POON, Hong Kong (HK)

(73) Assignee: SOLAR UNDERGROUND LIMITED, Hong Kong (HK)

(21) Appl. No.: 13/015,904

(22) Filed: Jan. 28, 2011

(51) Int. Cl. G08B 13/14

(52) U.S. Cl. 340/568.1

(57) ABSTRACT

A system is provided for monitoring containers buried in an enclosed area using battery-less GPS receivers. In one embodiment, an inventive system includes a GPS satellite, wherein the GPS satellite send GPS signals to the GPS receivers; a communication satellite; a monitored container that is buried in the enclosed area; a control system that serves as a monitoring system of the enclosed area; and a battery-less GPS receiver equipped with a solar panel that serves as a source for providing energy and equipped with a transmitter configured to send the satellite signals to the communication satellite.

### FIELD OF THE INVENTION

This invention is generally related to monitoring containers buried in enclosed areas. Specifically, but not limited to, this invention relates to monitoring containers buried in enclosed areas using battery-less GPS receivers.

### BACKGROUND OF THE INVENTION

There are many monitoring tools to monitor valuable items by using various kinds of technologies. Some of these tools are used to monitor items located indoor. Others are used to monitor items that are placed outdoor. Very few of the tools are used, however, to monitor items or goods that are laid underground. Thus, tools to monitor items or activities underground are highly sought by vendors around the world.

Commonly, monitoring tools use DC power as a main power source. The problem is, electrical equipments using DC power can only provide limited power lifespan. When power runs out, battery change is required to re-energize the equipment. This way of providing power may not be suitable for tools lying under the ground because doing so would require frequently battery change. This is inconvenient because goods stored underground may be stored for an infinite amount of time. It would be beneficial if the monitoring tools need not replace battery power in order to work in good condition when needed.

Wireless communication is becoming increasingly common as monitoring tools. Wireless communication refers to transfer of information without using a physical medium between 2 locations. Specifically, in convention technologies, wireless communications are used extensively. Such uses, for example, include radio communication, cell phone mobility, personal digital assistants (PDA), and other types of wireless networking. Among others, GPS (Global Positioning System) is a global navigation satellite system providing low cost while reliable positioning, navigation, and timing services to worldwide users on a continuous basis in the world which has an unobstructed view of GPS satellites. A GPS device can be any physical device that communicates with GPS satellites. A GPS device is made in different form factors. Examples of a GPS device include a PDA with GPS navigation capabilities, a handheld device placed in cars with location functions, and a notebook that equipped with remote navigation features. A GPS device relies on an embedded GPS receiver to detect GPS signals from GPS satellites, and the general principle requires a GPS receiver to operate in unobstructed manners. For conventional use, a GPS device is usually placed outdoor. When the GPS device is buried in the ground, the GPS receiver embedded is obstructed by matter, such as soil, concrete, or even wood that covers the GPS device from above. Under such circumstances, the GPS device hiding below the ground level cannot be located by the global position system. Thus, the global position system loses track of the GPS device buried in the ground and cannot detect any physical movement of the GPS device

Thus, in view of the foregoing, there is a need to monitor underground items using efficient technologies related to both wireless communications and different sorts of renewable energies. Such inventions can be useful in monitoring valuable goods stored underground. In one instance, such an invention can help those who are less willing to put their valuable goods in banks but at home for security purposes. Surprisingly, some of these people choose to put their valuable goods under the ground of the home. Monitor continuously the well being of their goods may be helpful to these home owners.

### SUMMARY OF THE INVENTION

Embodiments of the present invention include a system for monitoring containers buried in an enclosed area using battery-less GPS receivers. In one embodiment, the system includes a GPS satellite, wherein the GPS satellite send GPS signals to the GPS receivers; a communication satellite; a monitored container that is buried in the enclosed area; a control system that serves as a monitoring system of the enclosed area; and a battery-less GPS receiver equipped with a solar panel that serves as a source for providing energy and equipped with a transmitter configured to send the satellite signals to the communication satellite.

Further in the embodiment, the communication satellite receives satellite signals from GPS receivers and sends the satellite signals to control systems located on ground stations; the control system is configured to receive the satellite signals from the communication satellite, and to indicate status of the monitored container; and the status of the monitored container includes an offline mode, a standby mode, a first warning mode, and a second warning mode, the offline mode used to indicate that the monitored container has been buried, the first warning mode used to indicate that the obstructing matter above the monitored container has been removed, and the second warning mode used to indicate that the monitored container has been moved to a new location; and the receiver is physically attached to the GPS receiver and the GPS receiver is associated with one of receiver status, the status including the offline mode, the first warning mode, and the second warning mode, the offline mode used to indicate that the monitored container has been buried, and the GPS receiver is powered off for failing to receive sunlight; the first warning mode used to indicate that the obstructing matter above the monitored container has been removed, and the second warning mode used to indicate that the monitored container has been moved to the new location.

In accordance with one aspect of the embodiment, the communication satellite receives satellite signals from GPS receivers and sends the satellite signals to control systems located on ground stations; the control system is configured to receive the satellite signals from the communication satellite, and to indicate status of the monitored container, the status of the monitored container including an offline mode, a standby mode, a first warning mode, and a second warning mode, the offline mode indicating that the monitored container has been buried, the first warning mode indicating that the obstructing matter above the monitored container has been removed, and the second warning mode indicating that the monitored container has been moved to a different location; and the GPS receiver is physically attached onto the surface of the monitored container and covered by obstructing matter that obstructs the GPS receiver from receiving GPS signals from GPS satellite, and the GPS receiver is associated with one of receiver status, the status including the offline mode, the first warning mode, or the second warning mode, whereas in the offline mode, as the GPS receiver is being covered by the obstructing matter, the GPS receiver is powered off for failing to receive sunlight; in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container.

In another embodiment, a first GPS satellite, a second satellite, and a third GPS satellite, wherein the first, second, and third GPS satellites send GPS signals to GPS receivers, a communication satellite, wherein the communication satellite receives satellite signals from the GPS receivers and sends the satellite signals to control systems located on ground stations; a monitored container that is buried in the enclosed area; a control system that monitors the monitored container; and a battery-less GPS receiver equipped with a solar panel that serves as a source for providing energy and equipped with a transmitter configured to send the satellite signals to the communication satellite.

According to an additional embodiment, the control system is configured to receive the satellite signals from the communication satellite, and to indicate status of the monitored container, the status of the monitored container including an offline mode, a first warning mode, and a second warning mode, the offline mode indicating that the monitored container has been buried, the first warning mode indicating that the obstructing matter above the monitored container has been removed, and the second warning mode indicating that the monitored container has been moved to a different location; and the GPS receiver is physically attached inside the monitored container that is covered by obstructing matter that obstructs the GPS receiver from receiving GPS signals from the GPS satellite, and the GPS receiver is associated with one of receiver status, the status including the standby mode, the first warning mode, or the second warning mode, whereas in the offline mode, as the GPS receiver is being covered by the obstructing matter, the GPS receiver is powered off for failing to receive sunlight; in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container.

Alternatively, the control system is configured to receive the satellite signals from the communication satellite, and to indicate status of the monitored container, the status of the monitored container including an offline mode, a first warning mode, and a second warning mode, the offline mode indicating that the monitored container has been buried, the first warning mode indicating that the obstructing matter above the monitored container has been removed, and the second warning mode indicating that the monitored container has been moved to a different location.

In yet another alternative embodiment, the inventive system comprises an additional GPS receiver. This auxiliary GPS receiver can be used to complement with the GPS receiver at times where the auxiliary GPS receiver is being obstructed from receiving the GPS signals, wherein the auxiliary GPS receiver is physically attached onto the surface of the monitored container and covered by obstructing matter that obstructs the auxiliary GPS receiver from receiving GPS signals from the GPS satellite, and the auxiliary GPS receiver is associated with one of receiver status, the status including the offline mode, the first warning mode, or the second warning mode, whereas in the offline mode, as the auxiliary GPS receiver is being covered by the obstructing matter, the auxiliary GPS receiver is powered off for failing to receive sunlight; in the first warning mode, where the obstructing matter has been removed, the auxiliary GPS receiver is powered on after the solar panel receives sunlight, and the auxiliary GPS receiver successfully receives a first GPS signal from the GPS satellite, and sends a first satellite signal to the communication satellite to notify the control system regarding the removal of the obstructing matter; and in the second warning mode, where the auxiliary GPS receiver and the attached monitored container has been moved to the new location, the auxiliary GPS receiver receives the second GPS signal from the GPS satellite, and sends a second satellite signal to the communication satellite to notify the control system regarding the new location with respect to the auxiliary GPS receiver and the attached monitored container.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a system for monitoring containers buried in an enclosed area using battery-less GPS receivers, consistent with an embodiment of the invention.

### DETAILED DESCRIPTION

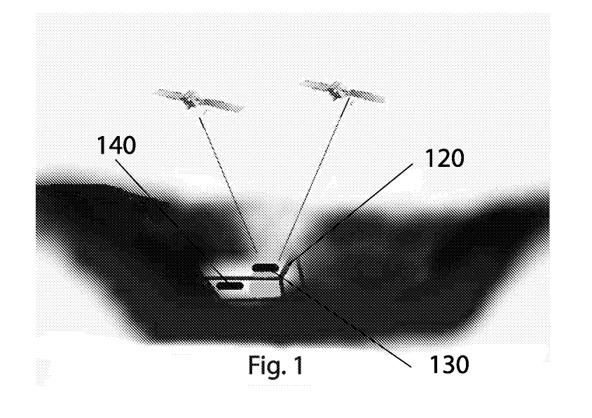

Embodiments of the present invention relates to a permanent wireless communication system for monitoring containers buried in an enclosed area using battery-less GPS receivers. Referring to FIG. 1, an exemplary system is illustrated. The system includes a GPS satellite (100), wherein the GPS satellite (100) send GPS signals to the GPS receivers; a communication satellite (110), wherein the communication satellite (110) receives satellite signals from GPS receivers and sends the satellite signals to control systems located on ground stations; a monitored container (120) that is buried in the enclosed area; a control system (130) that serves as a monitoring system of the enclosed area, wherein the control system (130) is configured to receive the satellite signals from the communication satellite (110), and to indicate status of the monitored container (120); and the status of the monitored container (120) includes an offline mode, a standby mode, a first warning mode, and a second warning mode, the offline mode used to indicate that the monitored container (120) has been buried, the first warning mode used to indicate that the obstructing matter above the monitored container (120) has been removed, and the second warning mode used to indicate that the monitored container (120) has been moved to a new location; and a battery-less GPS receiver (140) equipped with a solar panel that serves as a source for providing energy and equipped with a transmitter configured to send the satellite signals to the communication satellite (110), wherein the receiver is physically attached to the GPS receiver (140) and the GPS receiver (140) is associated with one of receiver status, the status including the offline mode, the first warning mode, and the second warning mode, the offline mode used to indicate that the monitored container (120) has been buried, and the GPS receiver (140) is powered off for failing to receive sunlight; the first warning mode used to indicate that the obstructing matter above the monitored container (120) has been removed, and the second warning mode used to indicate that the monitored container (120) has been moved to the new location.

In a different aspect of the invention, the inventive system comprises a GPS satellite (100), wherein the GPS satellite (100) sends GPS signals to the GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a standby mode, a first warning mode, and a second warning mode,

the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached onto the surface of the monitored container (120) and covered by obstructing matter that obstructs the GPS receiver (140) from receiving GPS signals from GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120).

In another implementation, the inventive system comprises a permanent wireless communication system for monitoring containers buried in an enclosed area using battery-less GPS receivers, comprising a first GPS satellite (100), a second satellite, and a third GPS satellite (100), wherein the first, second, and third GPS satellites (100) send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached onto the surface of the monitored container (120) and covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120).

In another exemplary implementation, the present system includes a permanent wireless communication system for monitoring containers in an enclosed area using battery-less GPS receivers, comprising a first GPS satellite (100), a second satellite, and a third GPS satellite (100), wherein the first, second, and third GPS satellites (100) send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached inside the monitored container (120) that is covered by obstructing matter that obstructs the GPS receiver (140) from receiving GPS signals from the GPS satellite (100), and the GPS receiver (140) is associated with one of receiver status, the status including the standby mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120).

In yet a alternative implementation, a system is provided, comprising a A permanent wireless communication system for monitoring containers buried in an enclosed area using battery-less GPS receivers, comprising a first GPS satellite (100), a second satellite, and a third GPS satellite (100), wherein the first, second, and third GPS satellites (100) send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached inside the monitored container (120) that is covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120).

In one other embodiment, a permanent wireless communication system is provided for monitoring containers in an enclosed area using battery-less GPS receivers, comprising a first GPS satellite (100), a second satellite, and a third GPS satellite (100), wherein the first, second, and third GPS satellites (100) send GPS signals to GPS receivers; a communication satellite (110), wherein the communication satellite (110) receives satellite signals from the GPS receivers and sends the satellite signals to control systems located on ground stations; a monitored container (120) that is buried in the enclosed area, wherein the monitored container (120) contains buried subject matter; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached to the buried subject matter contained in the monitored container (120) that is covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached buried subject matter has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached buried subject matter.

Alternatively, the system may be implemented in which it belongs to a permanent wireless communication system for monitoring containers in an enclosed area using battery-less GPS receivers, comprising a first GPS satellite (100), a second satellite, and a third GPS satellite (100), wherein the first, second, and third GPS satellites (100) send GPS signals to GPS receivers; a communication satellite (110), wherein the communication satellite (110) receives satellite signals from the GPS receivers and sends the satellite signals to control systems located on ground stations; a monitored container (120) that is buried in the enclosed area, wherein the monitored container (120) contains buried subject matter; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached to the buried subject matter contained in the monitored container (120) that is covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached buried subject matter has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached buried subject matter.

Further, a permanent wireless communication system is provided for monitoring containers in an enclosed area using battery-less GPS receivers, comprising a first GPS satellite (100), a second satellite, and a third GPS satellite (100), wherein the first, second, and third GPS satellites (100 send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; a battery-less GPS receiver (140) equipped with a solar panel that serves as a source for providing energy and equipped with a transmitter configured to send the satellite signals to the communication satellite (110), wherein the GPS receiver (140) is physically attached onto the surface of the monitored container (120) and covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120); and an auxiliary GPS receiver (140) to complement with the GPS receiver (140) at times where the auxiliary GPS receiver (140) is being obstructed from receiving the GPS signals, wherein the auxiliary GPS receiver (140) is physically attached onto the surface of the monitored container (120) and covered by obstructing matter that obstructs the auxiliary GPS receiver (140) from receiving GPS signals from the GPS satellite (100), and the auxiliary GPS receiver (140) is associated with one of receiver status, the status including the offline mode, the first warning mode, or the second warning mode, whereas in the offline mode, as the auxiliary GPS receiver (140) is being covered by the obstructing matter, the auxiliary GPS receiver (140) is powered off for failing to receive sunlight; in the first warning mode, where the obstructing matter has been removed, the auxiliary GPS receiver (140) is powered on after the solar panel receives sunlight, and the auxiliary GPS receiver (140) successfully receives a first GPS signal from the GPS satellite (100), and sends a first satellite signal to the communication satellite (110) to notify the control system (130) regarding the removal of the obstructing matter; and in the second warning mode, where the auxiliary GPS receiver (140) and the attached monitored container (120) has been moved to the new location, the auxiliary GPS receiver (140) receives the second GPS signal from the GPS satellite (100), and sends a second satellite signal to the communication satellite (110) to notify the control system (130) regarding the new location with respect to the auxiliary GPS receiver (140) and the attached monitored container (120).

In yet another implementation, a permanent wireless communication system is provided for monitoring containers in an enclosed area using battery-less GPS receivers, comprising a first GPS satellite (100), a second satellite, and a third GPS satellite (100), wherein the first, second, and third GPS satellites (100 send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a standby mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached onto the surface of the monitored container (120) and covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120); and an auxiliary GPS receiver (140) to complement with the GPS receiver (140) at times where the auxiliary GPS receiver (140) is being obstructed from receiving the GPS signals, wherein the auxiliary GPS receiver (140) is physically attached onto the surface of the monitored container (120) and covered by obstructing matter that obstructs the auxiliary GPS receiver (140) from receiving GPS signals from the GPS satellite (100), and the auxiliary GPS receiver (140) is associated with one of receiver status, the status including the offline mode, the first warning mode, or the second warning mode, whereas in the offline mode, as the auxiliary GPS receiver (140) is being covered by the obstructing matter, the auxiliary GPS receiver (140) is powered off for failing to receive sunlight; in the first warning mode, where the obstructing matter has been removed, the auxiliary GPS receiver (140) is powered on after the solar panel receives sunlight, and the auxiliary GPS receiver (140) successfully receives a first GPS signal from the GPS satellite (100), and sends a first satellite signal to the communication satellite (110) to notify the control system (130) regarding the removal of the obstructing matter; and in the second warning mode, where the auxiliary GPS receiver (140) and the attached monitored container (120) has been moved to a new location, the auxiliary GPS receiver (140) receives a second GPS signal from the GPS satellite (100), and sends a second satellite signal to the communication satellite (110) to notify the control system (130) regarding the new location with respect to the auxiliary GPS receiver (140) and the attached monitored container (120).

In an alternative implementation, a permanent wireless communication system is made for monitoring containers in an enclosed area using battery-less GPS receivers, comprising a first GPS satellite (100), a second satellite, and a third GPS satellite (100), wherein the first, second, and third GPS satellites (100 send GPS signals to GPS receivers; a communication satellite (110), wherein the communication satellite (110) receives satellite signals from the GPS receivers and sends the satellite signals to control systems located on ground stations; a monitored container (120) that is buried in the enclosed area; a control system (130) that monitors the monitored container (120), wherein the control system (130) is configured to receive the satellite signals from the communication satellite (110), and to indicate status of the monitored container (120), the status of the monitored container (120) including an offline mode, a standby mode, a first warning mode, and a second warning mode, the offline mode indicating that the monitored container (120) has been buried, the first warning mode indicating that the obstructing matter above the monitored container (120) has been removed, and the second warning mode indicating that the monitored container (120) has been moved to a different location; and a battery-less GPS receiver (140) equipped with a solar panel that serves as a source for providing energy and equipped with a transmitter configured to send the satellite signals to the communication satellite (110), wherein the GPS receiver (140) is physically attached inside the monitored container (120) that is covered by obstructing matter that obstructs the GPS receiver (140) from receiving GPS signals from the GPS satellite (100), and the GPS receiver (140) is associated with one of receiver status, the status including the offline mode, the first warning mode, or the second warning mode, whereas in the offline mode, as the GPS receiver (140) is being covered by the obstructing matter, the GPS receiver (140) is powered off for failing to receive sunlight; in the first warning mode, where the obstructing matter has been removed, the GPS receiver (140) is powered on after the solar panel receives sunlight, and the GPS receiver (140) successfully receives a first GPS signal from the GPS satellite (100), and sends a first satellite signal to the communication satellite (110) to notify the control system (130) regarding the removal of the obstructing matter; and in the second warning mode, where the GPS receiver (140) and the attached monitored container (120) has been moved to a new location, the GPS receiver (140) receives a second GPS signal from the GPS satellite (100), and sends a second satellite signal to the communication satellite (110) to notify the control system (130) regarding the new location with respect to the GPS receiver (140) and the attached monitored container (120); and an auxiliary GPS receiver (140) to complement with the GPS receiver (140) at times where the auxiliary GPS receiver (140) is being obstructed from receiving the GPS signals, wherein the auxiliary GPS receiver (140) is physically attached inside the monitored container (120) that is covered by obstructing matter that obstructs the auxiliary GPS receiver (140) from receiving GPS signals from the GPS satellite (100), and the auxiliary GPS receiver (140) is associated with one of receiver status, the status including the offline mode, the first warning mode, or the second warning mode, whereas in the offline mode, as the auxiliary GPS receiver (140) is being covered by the obstructing matter, the auxiliary GPS receiver (140) is powered off for failing to receive sunlight; in the first warning mode, where the obstructing matter has been removed, the auxiliary GPS receiver (140) is powered on after the solar panel receives sunlight, and the auxiliary GPS receiver (140) successfully receives a first GPS signal from the GPS satellite (100), and sends a first satellite signal to the communication satellite (110) to notify the control system (130) regarding the removal of the obstructing matter; and in the second warning mode, where the auxiliary GPS receiver (140) and the attached monitored container (120) has been moved to a new location, the auxiliary GPS receiver (140) receives a second GPS signal from the GPS satellite (100), and sends a second satellite signal to the communication satellite (110) to notify the control system (130) regarding the new location with respect to the auxiliary GPS receiver (140) and the attached monitored container (120).

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A permanent wireless communication system for monitoring containers buried in an enclosed area using battery-less GPS receivers, comprising
a GPS satellite, wherein:
the GPS satellite send GPS signals to the GPS receivers;
a communication satellite;
a monitored container that is buried in the enclosed area;
a control system that serves as a monitoring system of the enclosed area; and
a battery-less GPS receiver equipped with a solar panel that serves as a source for providing energy and equipped with a transmitter configured to send the satellite signals to the communication satellite.

2. The system of claim 1, wherein:
the communication satellite receives satellite signals from GPS receivers and sends the satellite signals to control systems located on ground stations;
the control system is configured to receive the satellite signals from the communication satellite, and to indicate status of the monitored container; and the status of the monitored container includes an offline mode, a standby mode, a first warning mode, and a second warning mode,
the offline mode used to indicate that the monitored container has been buried,
the first warning mode used to indicate that the obstructing matter above the monitored container has been removed, and
the second warning mode used to indicate that the monitored container has been moved to a new location; and
the receiver is physically attached to the GPS receiver and the GPS receiver is associated with one of receiver status, the status including the offline mode, the first warning mode, and the second warning mode,
the offline mode used to indicate that the monitored container has been buried, and the GPS receiver is powered off for failing to receive sunlight;
the first warning mode used to indicate that the obstructing matter above the monitored container has been removed, and
the second warning mode used to indicate that the monitored container has been moved to the new location.

3. The system of claim 1, wherein:
the communication satellite receives satellite signals from GPS receivers and sends the satellite signals to control systems located on ground stations;
the control system is configured to receive the satellite signals from the communication satellite, and to indicate status of the monitored container, the status of the monitored container including an offline mode, a standby mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location; and
the GPS receiver is physically attached onto the surface of the monitored container and covered by obstructing matter that obstructs the GPS receiver from receiving GPS signals from GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container.

4. A permanent wireless communication system for monitoring containers buried in an enclosed area using battery-less GPS receivers, comprising
a first GPS satellite, a second satellite, and a third GPS satellite, wherein the first, second, and third GPS satellites send GPS signals to GPS receivers;
a communication satellite, wherein the communication satellite receives satellite signals from the GPS receivers and sends the satellite signals to control systems located on ground stations;
a monitored container that is buried in the enclosed area;
a control system that monitors the monitored container; and
a battery-less GPS receiver equipped with a solar panel that serves as a source for providing energy and equipped with a transmitter configured to send the satellite signals to the communication satellite.

5. The system of claim 4, wherein:
the control system is configured to receive the satellite signals from the communication satellite, and to indicate status of the monitored container, the status of the monitored container including an offline mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location; and
the GPS receiver is physically attached inside the monitored container that is covered by obstructing matter that obstructs the GPS receiver from receiving GPS signals from the GPS satellite, and the GPS receiver is associated with one of receiver status, the status including the standby mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container.

6. The system of claim 4, wherein:
the control system is configured to receive the satellite signals from the communication satellite, and to indicate status of the monitored container, the status of the monitored container including an offline mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location; and
the GPS receiver is physically attached inside the monitored container that is covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container.

7. The system of claim 4, wherein:
the monitored container contains buried subject matter;
the control system is configured to receive the satellite signals from the communication satellite, and to indicate status of the monitored container, the status of the monitored container including an offline mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location; and
the GPS receiver is physically attached to the buried subject matter contained in the monitored container that is covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter.

8. The system of claim 4, wherein:
the monitored container contains buried subject matter;
the control system is configured to receive the satellite signals from the communication satellite, and to indicate status of the monitored container, the status of the monitored container including an offline mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location; and
the GPS receiver is physically attached to the buried subject matter contained in the monitored container that is covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter.

9. The system of claim 4, wherein:
the control system is configured to receive the satellite signals from the communication satellite, and to indicate status of the monitored container, the status of the monitored container including an offline mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location;
the GPS receiver is physically attached onto the surface of the monitored container and covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container; and
the system further comprises:
an auxiliary GPS receiver to complement with the GPS receiver at times where the auxiliary GPS receiver is being obstructed from receiving the GPS signals, wherein the auxiliary GPS receiver is physically attached onto the surface of the monitored container and covered by obstructing matter that obstructs the auxiliary GPS receiver from receiving GPS signals from the GPS satellite, and the auxiliary GPS receiver is associated with one of receiver status, the status including the offline mode, the first warning mode, or the second warning mode, whereas:
in the offline mode, as the auxiliary GPS receiver is being covered by the obstructing matter, the auxiliary GPS receiver is powered off for failing to receive sunlight;
in the first warning mode, where the obstructing matter has been removed, the auxiliary GPS receiver is powered on after the solar panel receives sunlight, and the auxiliary GPS receiver successfully receives a first GPS signal from the GPS satellite, and sends a first satellite signal to the communication satellite to notify the control system regarding the removal of the obstructing matter; and
in the second warning mode, where the auxiliary GPS receiver and the attached monitored container has been moved to the new location, the auxiliary GPS receiver receives the second GPS signal from the GPS satellite, and sends a second satellite signal to the communication satellite to notify the control system regarding the new location with respect to the auxiliary GPS receiver and the attached monitored container.

10. The system of claim 4, wherein:
the control system is configured to receive the satellite signals from the communication satellite, and to indicate status of the monitored container, the status of the monitored container including an offline mode, a standby mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location;
the GPS receiver is physically attached onto the surface of the monitored container and covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container; and
the system further comprises
an auxiliary GPS receiver to complement with the GPS receiver at times where the auxiliary GPS receiver is being obstructed from receiving the GPS signals, wherein the auxiliary GPS receiver is physically attached onto the surface of the monitored container and covered by obstructing matter that obstructs the auxiliary GPS receiver from receiving GPS signals from the GPS satellite, and the auxiliary GPS receiver is associated with one of receiver status, the status including the offline mode, the first warning mode, or the second warning mode, whereas:
in the offline mode, as the auxiliary GPS receiver is being covered by the obstructing matter, the auxiliary GPS receiver is powered off for failing to receive sunlight;
in the first warning mode, where the obstructing matter has been removed, the auxiliary GPS receiver is powered on after the solar panel receives sunlight, and the auxiliary GPS receiver successfully receives a first GPS signal from the GPS satellite, and sends a first satellite signal to the communication satellite to notify the control system regarding the removal of the obstructing matter; and
in the second warning mode, where the auxiliary GPS receiver and the attached monitored container has been moved to a new location, the auxiliary GPS receiver receives a second GPS signal from the GPS satellite, and sends a second satellite signal to the communication satellite to notify the control system regarding the new location with respect to the auxiliary GPS receiver and the attached monitored container.

11. The system of claim 4, wherein:
the control system is configured to receive the satellite signals from the communication satellite, and to indicate status of the monitored container, the status of the monitored container including an offline mode, a standby mode, a first warning mode, and a second warning mode,
the offline mode indicating that the monitored container has been buried,
the first warning mode indicating that the obstructing matter above the monitored container has been removed, and
the second warning mode indicating that the monitored container has been moved to a different location;
the GPS receiver is physically attached inside the monitored container that is covered by obstructing matter that obstructs the GPS receiver from receiving GPS signals from the GPS satellite, and the GPS receiver is associated with one of receiver status, the status including the offline mode, the first warning mode, or the second warning mode, whereas:
in the offline mode, as the GPS receiver is being covered by the obstructing matter, the GPS receiver is powered off for failing to receive sunlight;
in the first warning mode, where the obstructing matter has been removed, the GPS receiver is powered on after the solar panel receives sunlight, and the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored container has been moved to a new location, the GPS receiver receives a second GPS signal from the GPS satellite, and sends a second satellite signal to the communication satellite to notify the control system regarding the new location with respect to the GPS receiver and the attached monitored container; and
the system further comprises
an auxiliary GPS receiver to complement with the GPS receiver at times where the auxiliary GPS receiver is being obstructed from receiving the GPS signals, wherein the auxiliary GPS receiver is physically attached inside the monitored container that is covered by obstructing matter that obstructs the auxiliary GPS receiver from receiving GPS signals from the GPS satellite, and the auxiliary GPS receiver is associated with one of receiver status, the status including the offline mode, the first warning mode, or the second warning mode, whereas:
in the offline mode, as the auxiliary GPS receiver is being covered by the obstructing matter, the auxiliary GPS receiver is powered off for failing to receive sunlight;
in the first warning mode, where the obstructing matter has been removed, the auxiliary GPS receiver is powered on after the solar panel receives sunlight, and the auxiliary GPS receiver successfully receives a first GPS signal from the GPS satellite, and sends a first satellite signal to the communication satellite to notify the control system regarding the removal of the obstructing matter; and
in the second warning mode, where the auxiliary GPS receiver and the attached monitored container has been moved to a new location, the auxiliary GPS receiver receives a second GPS signal from the GPS satellite, and sends a second satellite signal to the communication satellite to notify the control system regarding the new location with respect to the auxiliary GPS receiver and the attached monitored container.
